(19) United States
(12) Patent Application Publication
(10) Pub. No.: US 2006/0201972 A1
(43) Pub. Date: Sep. 14, 2006

(54) Spice shaker device

(76) Inventor: Brett Di Paolo, Brampton (CA)

Correspondence Address: GEORGE A. ROLSTON, 45 SHEPPARD AVE EAST, SUITE 900, TORONTO, ON, M2N5W9, CA

(21) Appl. No.: 11/371,081

(22) Filed: Mar. 9, 2006

Related U.S. Application Data
(60) Provisional application No. 60/659,419, filed on Mar. 9, 2005.

(51) Int. Cl. B67D 5/64; A47G 19/24

(52) U.S. Cl. 222/174; 222/142.1

(57) ABSTRACT

A spice shaker device including an elongate handle member having a first end and an opposite second end, and a head member provided on the second end of the elongate handle member, the head member including one or more containers for dispensing spices.

### FIELD OF THE INVENTION

The invention relates to a spice shaker device, and more particularly to a spice shaker device for seasoning food on a barbeque.

### PRIOR APPLICATION

This application claims the benefit of U.S. Provisional Application Ser. No. 60/659,419, filed Mar. 9, 2005, entitled SPICE SHAKER DEVICE.

### BACKGROUND OF THE INVENTION

Outdoor barbequing is an increasingly popular cooking technique which produces foods, such as steaks, chicken and vegetables, having unique flavors and textures which cannot be easily duplicated in a traditional kitchen. Properly seasoning of the food during the barbequing process is essential to maximizing the taste and quality of finished, cooked foods. As the rate at which foods sear and cook on a barbeque is considerably faster than in an oven, there is often limited time to apply each of the seasonings and to allow the seasonings to absorb into the food. Commonly, barbeque users utilize individual spice shakers, such as for steak spice, pepper and oregano, and apply the seasonings to the food in succession. When in a rush to apply the seasonings, the barbeque user will often apply to much or too little seasoning, thereby potentially ruining the finished, cooked food. Rushing to apply the seasoning using traditional seasoning shakers, such as a salt shaker, may also result in the barbeque user accidentally burning their hand, wrist or arm on the barbeque.

Accordingly, there is a need for a spice shaker device for use when barbequing consisting of one or more seasoning containers provided on an elongate handle member. There is a further need for a spice shaker device consisting of one or more seasoning containers having lids which are independently adjustable to control the flow of seasonings from each of the containers.

### SUMMARY OF THE INVENTION

The present invention is directed to a spice shaker device including an elongate handle member having a first end and an opposite second end, and a head member secured on the second end of the elongate handle member, the head member including one or more containers for dispensing spices. The one or more containers having an open end and a closed end, wherein the open end is adapted to receive a lid portion. The one or more containers having an inner surface and an outer surface, wherein the outer surface adjacent to the open end of the one or more containers is provided with one or more circumferential ridges to facilitate the sliding engagement of the lid portion over the open end of the container. The one or more containers including a cap portion that is rotatable relative to the lid portion for controlling the passage and dispensing of spices. The one or more containers are integrally formed in the head member.

The first end of the elongate handle member is provided with a heat-resistant sleeve. The first end of the elongate handle member is provided with a hook means. The elongate handle member and the head member are made of a metallic material or polypropylene.

The present invention is also directed to a spice shaker device including a head member having one or more loop portions each having an inside surface, and wherein each of the inside surfaces are adapted to receive and releasably retain the one or more containers.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 is a perspective view of a spice shaker device made in accordance with a preferred embodiment of the invention;

FIG. 2 is an exploded perspective view of the head member and one or more containers of the spice shaker device of FIG. 1;

FIG. 4 is a perspective view of a spice shaker device made in accordance with an alternative embodiment of the invention; and

FIG. 4 is a perspective view a spice shaker device made in accordance with an alternative embodiment of the invention.

### DETAILED DESCRIPTION OF THE INVENTION

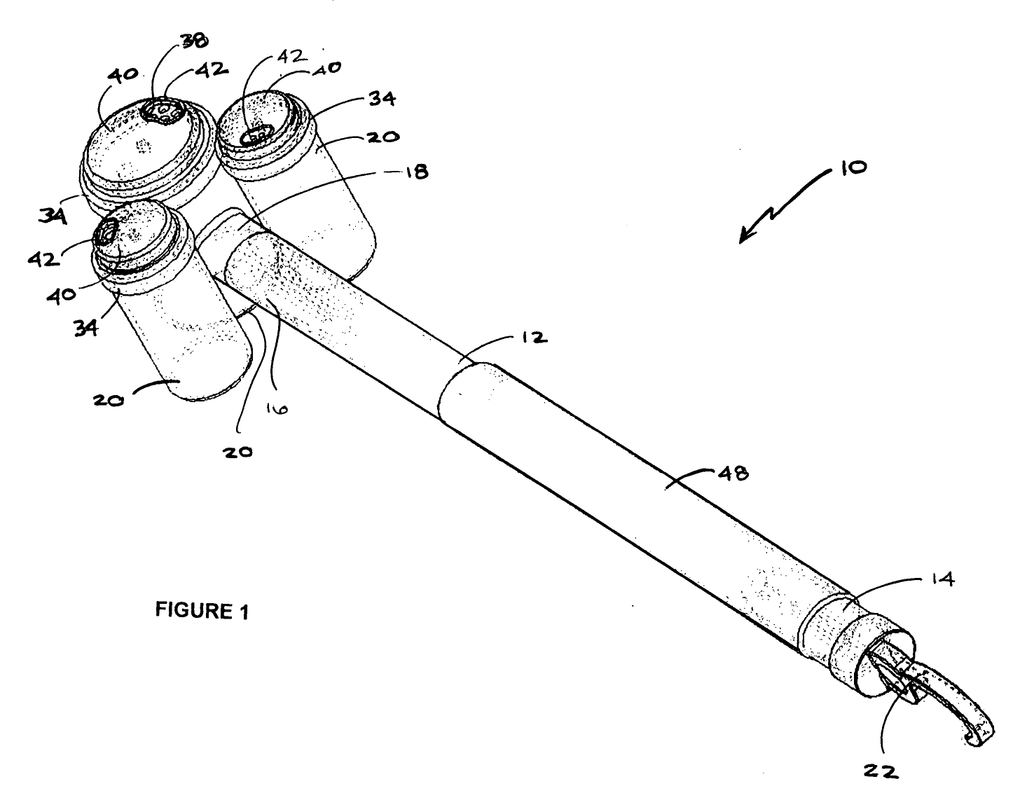

Reference is made to FIGS. 1, 2 and 3 which illustrate a spice shaker device 10 for use when barbequing made in accordance with a preferred embodiment of the invention. Spice shaker device 10 has an elongate handle member 12 having a first end 14 and an opposite second end 16, and a head member 18. The head member 18 is secured to the second end 16 of the elongate handle member 12, and includes one or more containers 20 for containing and dispensing various spices and seasonings. In a preferred embodiment, the one or more containers 20 are integrally formed with the head member 18. The first end 18 of the elongate handle member 12 may have an optional hook means 22 to allow the spice shaker device 10 to be attached to a barbeque or the barbeque user's belt.

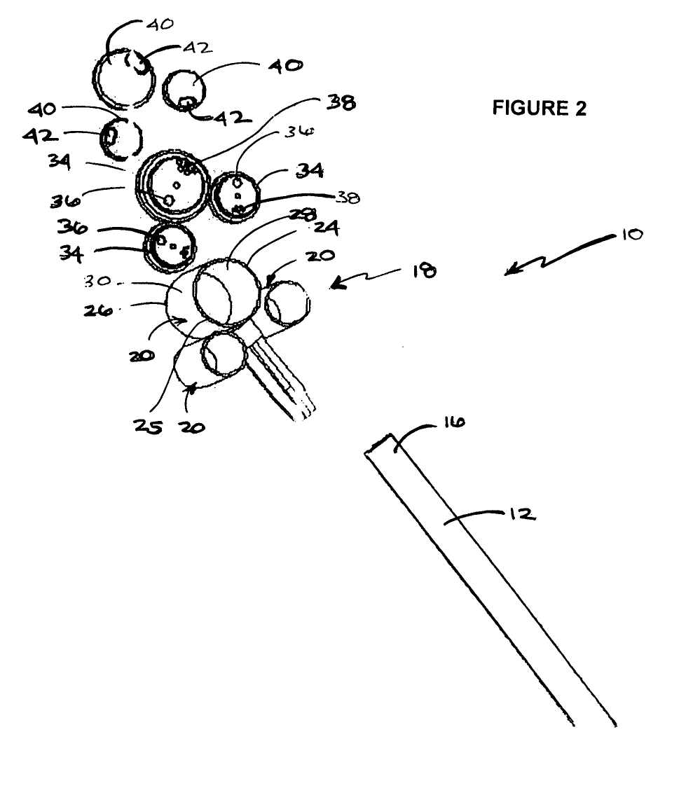

In an embodiment of the invention shown in FIGS. 1 and 2, each of the one or more containers 20 are generally cylindrical with an open end 24 and a closed end 26. The one or more containers have an inner surface 28 and an outer surface 30. The outer surface 32 of the one or more containers 20 adjacent to the open end 24 is provided with one or more circumferential ridges 25 which are adapted to facilitate the sliding engagement of a lid portion 34 over the open end of each of the one or more containers 20. The lid portion 34 is formed with a first opening 36 designed to allow the passage and dispensing of the various spices and seasonings from each of the one or more containers 20. At least one additional opening 38 may be formed in the lid portion 34, wherein the at least one additional opening 38 having a different dimension than that of the first opening 36 so as to enable the passage and dispensing of spices and seasonings from each of the one or more containers 20 at a slower or faster rate. A cap portion 40 having one or more dispensing openings 42 may be releasably engaged to the lid portion 34. The cap portion 40 being adapted to be rotated relative to the lid portion 40 to enable the barbeque user to position the one or more dispensing openings 42 in communication with the first opening 36 or the at least one additional opening 38 on the lid portion 40. By this design, the barbeque user may control the rate and the amount of spices and seasonings that will be dispensed from the one or more containers 20 when using the spice shaker device 10.

To season foods on a barbeque using the spice shaker device 10, the barbeque user rotatably adjusts the cap portion 40 relative to the lid portion 34 to select and control the amount of spices and seasonings that will be dispensed from each of the one or more containers 20. The barbeque user holding the first end 14 of the elongate handle member 12 then generally inverts and shakes the spice shaker device 10 to cause the spices and seasonings to dispense from the containers.

It should be understood that the one or more containers 20 may be any suitable shape or dimension. Further it should be understood that any various means for allowing the passage and dispensing of spices and seasonings from the one or more containers may be used with the present invention.

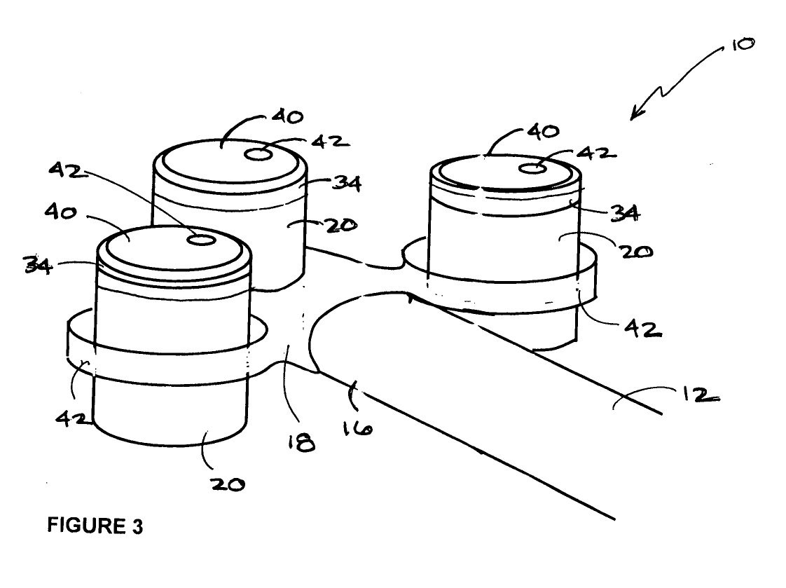

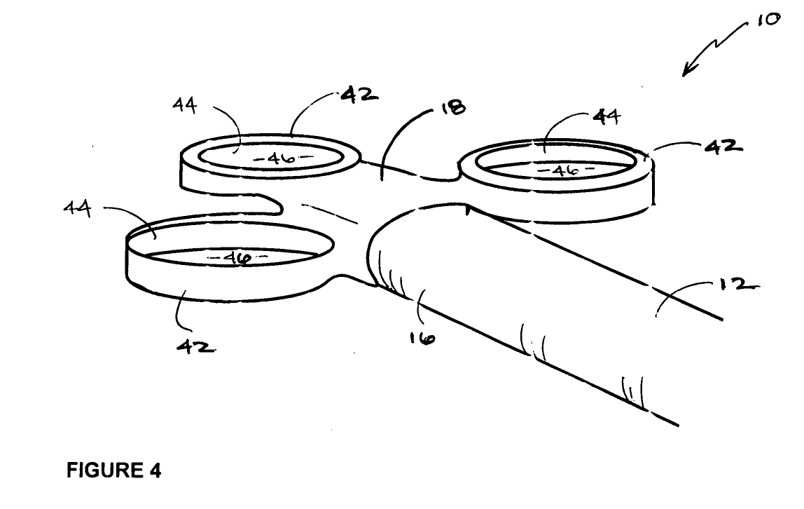

In an alternative embodiment of the present invention shown in FIG. 3 and 4, the head member 18 of the spice shaker device 10 has one or more loop portions 42 which are adapted to slidably receive a corresponding container 20. The one or more loop portions 42 have an inside surface 44 that defines a generally circular aperture 46 which receives and releaseably retains the one or more containers 20. By this design, the barbeque user may easily replace one or more of the containers 20 with a new series of spices and seasonings, or to replace empty containers 20.

In a further embodiment of the present invention, the first end 14 of the elongate handle member 12 may be provided with a heat-resistant sleeve 48 to minimize the transmission of heat from the spice shaker device 10 to the hand of the barbeque user. The heat-resistant sleeve 48 may be made of any suitable material, such as, for example, polypropylene. It should be understood that the elongate handle member 12 and the head member 18 may be manufactured from any suitable material known by persons skilled in the art. For example, the elongate handle member 12 and the head member 18 may be manufactured from polypropylene or a metallic material, such as stainless steel. It should be further understood that the length of the elongate handle member 12 should be sufficient to ensure that the hands and arms of the barbeque user are a safe distance away from the barbeque.

The present invention has been described with regard to specific embodiments. However, it will obvious to persons skilled in the art that a number of variants and modifications can be made without departing from the scope and spirit of the invention, the scope of which is defined in the appended claims.

1. A spice shaker device, comprising:
an elongate handle member having a first end and an opposite second end; and
a head member secured on the second end of the elongate handle member, the head member including one or more containers for dispensing spices.

2. The spice shaker device as claimed in claim 1, wherein the one or more containers having an open end and a closed end, and wherein the open end is adapted to receive a lid portion.

3. The spice shaker device as claimed in claim 2, wherein the one or more containers having an inner surface and an outer surface, wherein the outer surface adjacent to the open end of the one or more containers is provided with one or more circumferential ridges to facilitate the sliding engagement of the lid portion over the open end of the container.

4. The spice shaker device as claimed in claim 3 wherein the one or more containers including a cap portion that is rotatable relative to the lid portion for controlling the passage and dispensing of spices.

5. The spice shaker device as claimed in claim 1, wherein the head member having one or more loop portions each having an inside surface, and wherein each of the inside surfaces are adapted to receive and releasably retain the one or more containers.

6. The spice shake device as claimed in claim 1, wherein the one or more containers are integrally formed in the head member.

7. The spice shaker device as claimed in claim 1, wherein the first end of the elongate handle member is provided with a heat-resistant sleeve.

8. The spice shaker device as claimed in claim 1, wherein the handle member and the head member are made of a metallic material.

9. The spice shaker device as claimed in claim 1, wherein the handle member and the head member are made of polypropylene.

10. The multi-purpose cooking utensil as claimed in claim 1, wherein the first end of the elongate handle member is provided with a hook means.

11. A spice shaker device, comprising:
an elongate handle member having a first end and an opposite second end; and
a head member provided on the second end of the elongate handle member, the head member including one or more containers, each of the containers having a lid portion having a first opening for allowing the passage and dispensing of spices

12. The spice shaker device as claimed in claim 11, wherein the one or more containers including a cap portion that is rotatable relative to the lid portion for controlling the passage and dispensing of spices.
